(19) United States
(12) Patent Application Publication
(10) Pub. No.: US 2006/0219353 A1
(43) Pub. Date: Oct. 5, 2006

(54) Protective tape cutting method and apparatus using the same

(75) Inventors: Norio Mori, Mie-ken (JP); Masayuki Yamamoto, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation

(21) Appl. No.: 11/359,432

(22) Filed: Feb. 23, 2006

(30) Foreign Application Priority Data
Mar. 29, 2005 (JP) JP2005-094849

(51) Int. Cl. B32B 38/00; B26D 7/10; B32B 37/00; B32B 41/00; B32B 38/04

(52) U.S. Cl. 156/267; 156/250; 156/510; 156/522; 156/523; 156/353; 156/378; 83/15

(57) ABSTRACT

A cutter blade cooling part is operated by a first temperature control part to regulate a temperature and flow amount of cooled air blown on a cutter blade and heating of the cutter blade by an electrothermal heater. Thus, a protective tape is cut while the temperature of the cutter blade is maintained at a temperature equal to or less than room temperature.

### BACKGROUND FO THE INVENTION

(1) Field of the Invention

The present invention relates to a protective tape cutting method for cutting a protective tape joined to a surface of a semiconductor wafer along a wafer outside shape by relatively running a cutter blade along an outer periphery of the semiconductor wafer, and an apparatus using this method.

(2) Description of the Related Art

As a configuration of a conventional protective tape cutting apparatus, there is known a configuration that a protective tape is supplied onto a surface of a wafer mounted on and held at a table and a joining roller is moved by rolling to join the protective tape onto the surface of the wafer. Then, with a cutter blade stuck into the protective tape, the table is turned to thereby relatively run the cutter blade along an outer periphery of the wafer and cut the protective tape along the outer periphery of the wafer. Depending on a type of the protective tape, the cutter blade is heated in cutting (see lines 13 to 18 in an upper left column on page 7 of JP-A 01-43458 (1989)).

However, in cutting the protective tape with the cutter blade, an adhesive of the protective tape may adhere to and remain on a side face of the cutter blade. If the adhesion of the adhesive proceeds, a cutting performance deteriorates in a short time. Especially when the cutter blade is heated to make cutting of the protective tape easy, the adhesive softened as a result of heating of the cutter blade becomes more liable to adhere to and remain on the side face of the cutter blade.

If the cutter blade is heated, the protective tape may be melted and deformed at a portion where the cutter blade is stuck into the protective tape depending on the type of the protective tape, which results in an unsatisfactory finish.

Moreover, in order to cut the protective tape properly along the outer peripheral edge of the wafer, the cutter blade is elastically pressed against the outer peripheral edge of the wafer. As a result, the cutter blade runs while being in sliding contact with the outer peripheral edge of the wafer. Frictional heat caused by the sliding contact further increases a temperature around a cutting edge to make the adhesion of the adhesive more liable to occur.

### SUMMARY OF THE INVENTION

The present invention has been made in view of the aforementioned circumstances and it is a main object of the present invention to provide a protective tape cutting method which prevents an adhesive from adhering to and remaining on a cutter blade to maintain satisfactory sharpness of the cutter blade for a long term, and an apparatus using this method.

In order to achieve the aforementioned object, the present invention employs the following configuration.

A method for cutting a protective tape joined to a surface of a semiconductor wafer formed with a pattern by moving a cutter blade along an outer periphery of the semiconductor wafer, the method comprising the step of:

cutting the protective tape while cooling the cutter blade with cooling means.

With this method of the present invention, because the cutter blade is cooled by the cooling means, it is possible to suppress softening of an adhesive on the protective tape due to heat of the cutter blade or heat generated by sliding contact of the cutter blade and an outer peripheral edge of the wafer. Therefore, it is possible to achieve cutting of the protective tape in which the adhesive is less liable to adhere to the cutter blade.

Preferably, in the cutting step, the cutter blade is cooled with the cooling means and is heated with heating means to regulate a temperature of a cutting edge to a temperature equal to or less than room temperature.

With this method, by adjusting a degree of cooling, cutting can be carried out at a predetermined temperature of the cutter blade which is suitable for cutting the protective tape, at which the adhesive is less liable to adhere, and which is equal to or less than room temperature.

In order to achieve the aforementioned object, the present invention also employs the following configuration.

A method for cutting a protective tape joined to a surface of a semiconductor wafer formed with a pattern by moving a cutter blade along an outer periphery of the semiconductor wafer, the method comprising the step of:

cutting the protective tape while cooling the protective tape with cooling means.

With this method of the present invention, the adhesive on the protective tape is cooled and hardened and becomes less liable to adhere to the cutter blade. Moreover, the protective tape cooled when the cutter blade is stuck into the protective tape is not melted or deformed due to the heat of the cutter blade. In other words, cutting with a satisfactory finish is carried out.

Preferably, in the cutting step, the protective tape is cooled with the cooling means and the cutter blade is heated with heating means to cut the protective tape while regulating a temperature of a portion of the protective tape with which the cutter blade is brought into contact to a temperature equal to or less than room temperature.

With this method, even if the heat from the cutter blade is transferred to the adhesive on the protective tape, the adhesive is immediately cooled and hardened and becomes less liable to adhere to the cutter blade. Moreover, the protective tape cooled when the cutter blade is stuck into the protective tape is not melted or deformed due to the heat of the cutter blade. In other words, cutting with a satisfactory finish is carried out.

In order to achieve the aforementioned object, the present invention also employs the following configuration.

An apparatus for cutting a protective tape joined to a surface of a semiconductor wafer formed with a pattern, the apparatus comprising:

holding means on and at which the semiconductor wafer is mounted and held;

protective tape joining means for joining the protective tape onto the surface of the semiconductor wafer mounted on and held at the holding means;

protective tape cutting means having a cutter blade, and allowing the cutter blade to penetrate the protective tape and to move along an outer periphery of the semiconductor wafer, thereby cutting the protective tape joined to the surface of the semiconductor wafer;

cutter blade cooling means for cooling the cutter blade of the protective tape cutting means; and

tape collecting means for collecting an unnecessary protective tape after cutting.

With this apparatus of the present invention, in cutting the protective tape joined to the semiconductor wafer mounted on and held at the holding means along the outer periphery of the wafer with the cutter blade, cutting can be carried out while cooling the cutter blade with the cooling means. In other words, the aforementioned method of the present invention can be realized properly.

Preferably, the cutter blade cooling means is a cooling nozzle for blowing a cooled gaseous body on the cutter blade to cool the cutter blade, or an electronic cooling element.

If the cutter blade cooling means is the cooling nozzle, the cutter blade can be cooled to a temperature suitable for tape cutting, and softening of the adhesive can be suppressed by cooling also the protective tape to a proper degree with cool air flowing around the cutter blade.

If the cutter blade cooling means is the electronic cooling element, a cooling function can arbitrarily be regulated by controlling electrical conduction of the electronic cooling element and the like. In other words, optimum cooling of the cutter blade according to a type of the protective tape and the like can be carried out.

Preferably, the apparatus of the present invention further comprises:

heating means for heating the cutter blade;

first temperature control means for operating the heating means and the cooling means to regulate a temperature of the cutter blade; and

a temperature sensor for detecting the temperature of the cutter blade, wherein

the first temperature control means compares a measured value detected by the temperature sensor and a predetermined reference value to obtain a deviation and operates the heating means or the cooling means according to the deviation to regulate the temperature of the cutter blade.

More preferably, the apparatus of the present invention further comprises:

tape cooling means for cooling the protective tape;

second temperature control means for operating the heating means and the tape cooling means to regulate the temperature of a portion of the protective tape to be cut; and

a temperature sensor for detecting the temperature of the portion of the protective tape to be cut, wherein

the second temperature control means compares a measured value detected by the temperature sensor and a predetermined reference value to obtain a deviation and operates at least the cooling means out of the heating means and the cooling means according to the deviation to regulate the temperature of the portion to be cut.

With this configuration, it is easy to strictly set the temperature of the cutter blade by combination of heating and cooling.

In order to achieve the aforementioned object, the present invention also employs the following configuration.

An apparatus for cutting a protective tape joined to a surface of a semiconductor wafer formed with a pattern, the apparatus comprising:

holding means on and at which the semiconductor wafer is mounted and held;

protective tape joining means for joining the protective tape onto the surface of the semiconductor wafer suction-held by the holding means;

protective tape cutting means having a cutter blade, and allowing the cutter blade to penetrate the protective tape and to move along an outer periphery of the semiconductor wafer, thereby cutting the protective tape joined to the surface of the semiconductor wafer;

tape cooling means for cooling the protective tape; and

tape collecting means for collecting an unnecessary protective tape after cutting.

With this configuration, in cutting the protective tape joined to the semiconductor wafer mounted on and held at the holding means along the outer periphery of the wafer with the cutter blade, cutting can be carried out while cooling the protective tape with the cooling means.

Preferably, the tape cooling means is a cooling nozzle for blowing a cooled gaseous body on and cooling the protective tape in a region in a vicinity of the cutter blade including a portion in contact with the cutter blade.

With this configuration, it is possible to arbitrarily set a portion to be cooled by regulating an orientation of the cooling nozzle to thereby carry out cutting with proper tape cooling adapted to the type of the protective tape and cutting conditions such as a cutting speed.

Preferably, the apparatus of the present invention further comprises:

heating means for heating the cutter blade;

second temperature control means for operating the heating means and the tape cooling means to regulate a temperature of a portion of the protective tape to be cut; and

a temperature sensor for detecting the temperature of the portion of the protective tape to be cut, wherein

the second temperature control means compares a measured value detected by the temperature sensor and a predetermined reference value to obtain a deviation and operates at least the cooling means out of the heating means and the cooling means according to the deviation to regulate the temperature of the portion to be cut.

With this structure, it is possible to strictly set the temperature of the portion to be cut by combination of heating of the cutter blade and cooling of the protective tape and to carry out tape cutting with a satisfactory finish without adhesion of the adhesive to the cutter blade.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a general perspective view of a protective tape cutting apparatus;

FIG. 2 is a side view of a tape cutting mechanism;

FIG. 3 is a front view of a protective tape joining step;

FIG. 4 is a front view of the protective tape joining step;

FIG. 5 is a front view of the protective tape joining step;

FIG. 6 is a front view of the protective tape joining step;

FIG. 7 is a front view of a first example of a main portion of the tape cutting mechanism; and

FIG. 8 is a front view of a second example of a main portion of the tape cutting mechanism.

### DESCRIPTION OF THE PREFERRED EMBODIMENTS

An embodiment of the present invention will be described below with reference to the drawings.

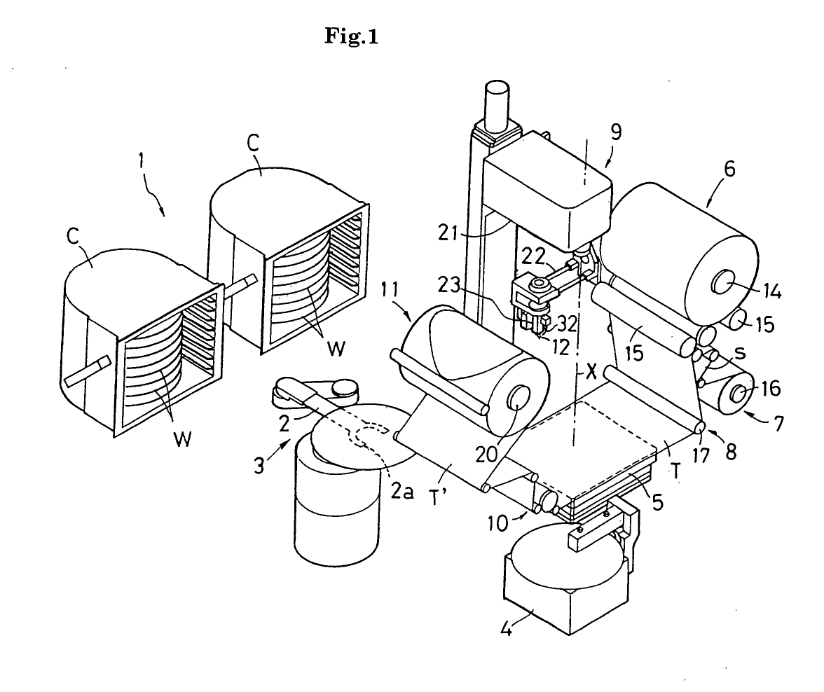

FIG. 1 is a general perspective view of a configuration of a protective tape cutting apparatus.

The protective tape cutting apparatus of the present embodiment includes a wafer supply/collection unit 1 in which cassettes C housing semiconductor wafers (hereafter, simply referred to as “wafers”) W are loaded, a wafer transportation mechanism 3 having a robot arm 2, an alignment stage 4, a chuck table 5 on and by which the wafer W is mounted and suction-held, a tape supply unit 6 for supplying a protective tape T toward the wafer W, a separator collection unit 7 for separating and collecting a separator s from the protective tape T with the separator supplied from the tape supply unit 6, a joining unit 8 for joining the protective tape T onto the wafer W mounted on and suction-held by the chuck table 5, a tape cutting mechanism 9 for cutting out the protective tape T joined to the wafer W along an outside shape of the wafer W, a separation unit 10 for separating an unnecessary tape T′ after it is joined to the wafer W and cut, a tape collection unit 11 for reeling and collecting the unnecessary tape T′ separated by the separation unit 10, and the like. Concrete configurations of the above respective components will be described below.

In the wafer supply/collection unit 1, two cassettes C can be loaded side by side. In each of the cassettes C, the large number of and multiple-stacked wafers W with their wiring pattern faces up are inserted and housed in horizontal attitudes.

The robot arm 2 provided to the wafer transportation mechanism 3 is formed to be able to move forward and backward in a horizontal direction and the whole of the robot arm 2 can be driven for turning and ascending/descending. To a tip end of the robot arm 2, a horseshoe-shaped vacuum suction-type wafer holding unit 2a is provided. The wafer holding unit 2a at this tip end portion is inserted into each of clearances between the multiple-stacked wafers W housed in the cassette C to suction-hold the wafer W from a back face. Then, the robot arm 2 draws the suction-held wafer W out of the cassette C to sequentially transport the wafer W to the alignment stage 4, the chuck table 5, and the wafer supply/collection unit 1, in this order.

The alignment stage 4 brings the wafer W which has been transported by and mounted on the wafer transportation mechanism 3 into alignment based on an orientation flat or a notch formed at an outer periphery of the alignment stage 4.

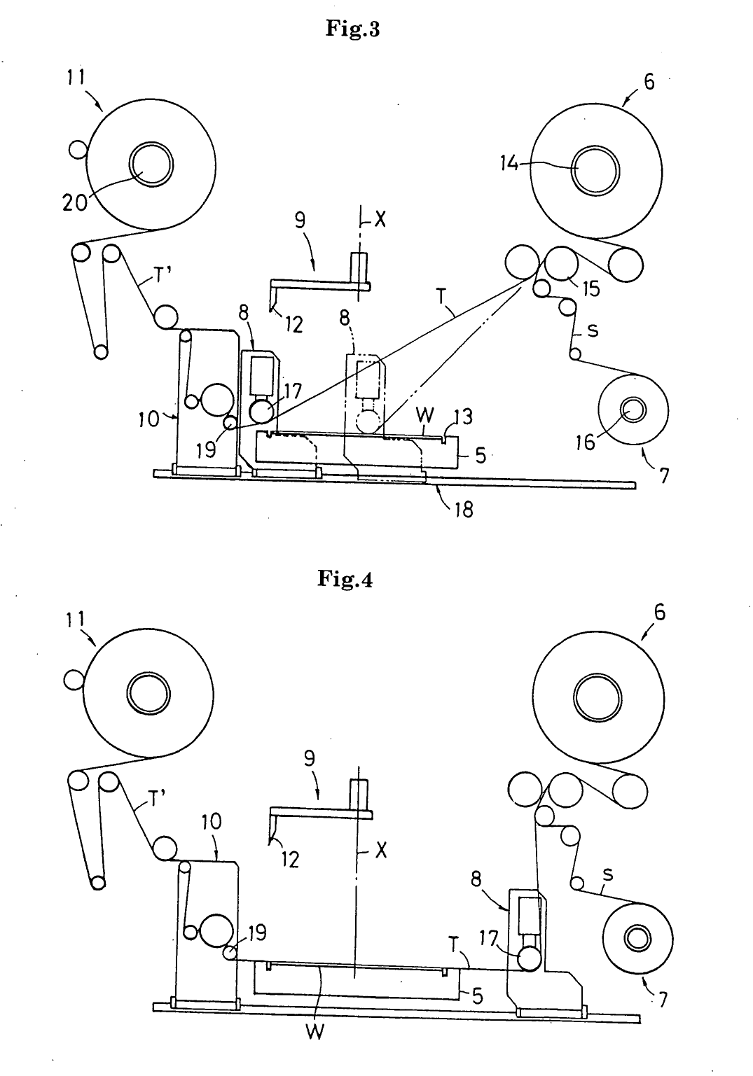

The chuck table 5 vacuum-sucks the wafer W which has been transferred from the wafer transportation mechanism 3 and mounted in a predetermined aligned attitude. In an upper face of the chuck table 5, as shown in FIG. 3, a cutter running groove 13 is formed so as to allow a cutter blade 12 which is provided to the tape cutting mechanism 9 and which will be described later to turn and move along the outside shape of the wafer W to cut the protective tape T. The chuck table 5 corresponds to holding means of the present invention.

The tape supply unit 6 guides the protective tape T with the separator and unreeled from a supply bobbin 14 to wind the tape T around a group 15 of guide rollers and leads the protective tape T from which the separator s has been separated to the joining unit 8. The supply bobbin 14 is provided with a proper degree of rotational resistance so as not to unreel an excessive amount of tape.

In the separator collection unit 7, a collecting bobbin 16 for reeling the separator s which has been separated from the protective tape T is driven to rotate in a reeling direction.

To the joining unit 8, a joining roller 17 is provided horizontally to face forward and is driven to reciprocate leftward and rightward in the horizontal direction by a slide guide mechanism 18 and a screw-feeding drive mechanism (not shown). The joining unit 8 corresponds to protective tape joining means of the present invention.

To the separation unit 10, a separating roller 19 is provided horizontally to face forward and is driven to reciprocate leftward and rightward in the horizontal direction by the slide guide mechanism 18 and the screw-feeding drive mechanism (not shown).

In the tape collection unit 11, a collecting bobbin 20 for reeling the unnecessary tape T′ is driven to rotate in a reeling direction. The tape collection unit 11 corresponds to tape collecting means of the present invention.

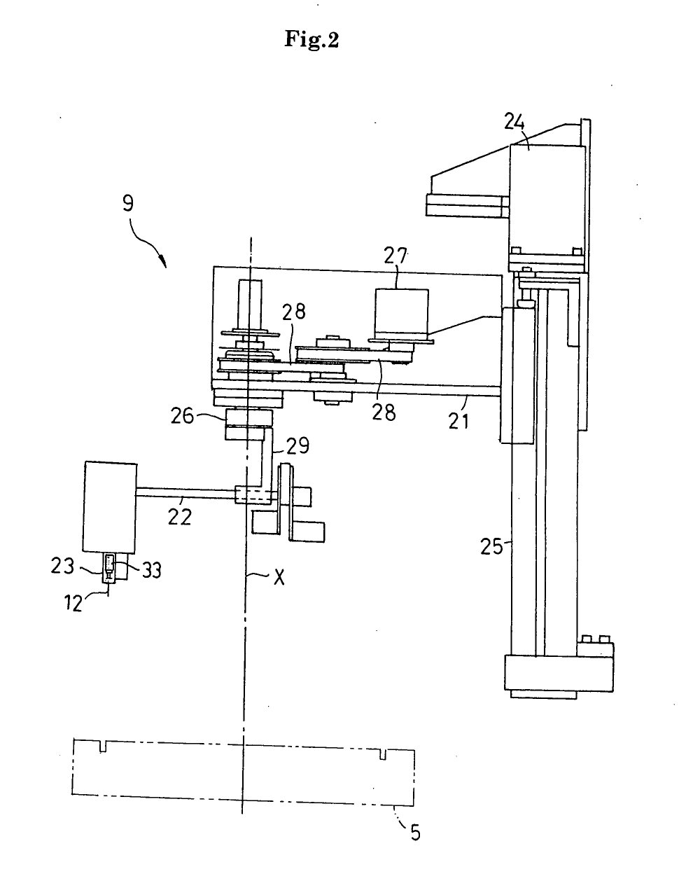

In the tape cutting mechanism 9, as shown in FIG. 2, a pair of support arms 22 are arranged side by side to be driven and turned about a vertical axis X positioned on a center of the chuck table 5 under a movable stage 21 which can be driven to upward and downward. A cutter holder 23 provided to free end sides of the support arms 22 is mounted with the cutter blade 12 with its cutting edge oriented downward. As the support arms 22 turn and move about the vertical axis X in a predetermined direction, the cutter blade 12 runs along the outer periphery of the wafer W to cut out the protective tape T. The movable stage 21 is moved upward/downward by screw-feeding along a vertical rail 25 by normally and reversely driving a motor 24 for rotation. A turning shaft 26 provided to a free end portion of the movable stage 21 for turning about the vertical axis X is interlocked while being slowed down with a motor 27 disposed on the movable stage 21 through two belts 28. By actuation of the motor 27, the turning shaft 26 is turned at a low speed in a predetermined direction. By penetrating a lower end portion of a support member 29 extending downward from the turning shaft 26, the support arms 22 are supported to be slide-adjusted in the horizontal direction and a distance from the vertical axis X to the cutter blade 12 is changed by the slide-adjustment of the support arms 22. In other words, it is possible to change and adjust a turning radius of the cutter blade 12 according to the wafer diameter. Although detailed description of a structure will be omitted, a cutting-in angle of a blade face with respect to a direction of running for cutting and an inclination angle of the blade face with respect to the peripheral edge of the wafer W of the cutter blade 12 are adjustable. The tape cutting mechanism 9 corresponds to protective tape cutting means of the present invention.

Next, a series of basic operations for joining the protective tape T onto a surface of the wafer W and cutting out the tape T by using the above apparatus will be described based on FIGS. 3 to 6.

When a joining command is issued, the robot arm 2 in the wafer transportation mechanism 3 is first moved toward the cassette C mounted and loaded on a cassette stage and the wafer holding unit 2a is inserted into the clearance between the wafers housed in the cassette C. Then, the wafer W is suction-held from its back face (lower face) by the wafer holding unit 2a and is carried out and the taken-out wafer W is transferred to the alignment stage 4.

The wafer W mounted on the alignment stage 4 is aligned by utilizing the notch formed at the outer periphery of the wafer W. The aligned wafer W is carried out again by the robot arm 2 and is mounted on the chuck table 5.

The wafer W mounted on the chuck table 5 is suction-held while being aligned so that a center of the wafer W is placed on a center of the chuck table 5. At this time, as shown in FIG. 3, the joining unit 8 and the separation unit 10 are on standby in initial positions on a left side. The cutter blade 12 of the tape cutting mechanism 9 is on standby in an initial upper position.

Next, as illustrated in phantom lines in FIG. 3, the joining roller 17 of the joining unit 8 is lowered and rolls forward (rightward in FIG. 3) on the wafer W while pressing the protective tape T downward. Thus, the protective tape T is joined to the whole surface of the wafer W.

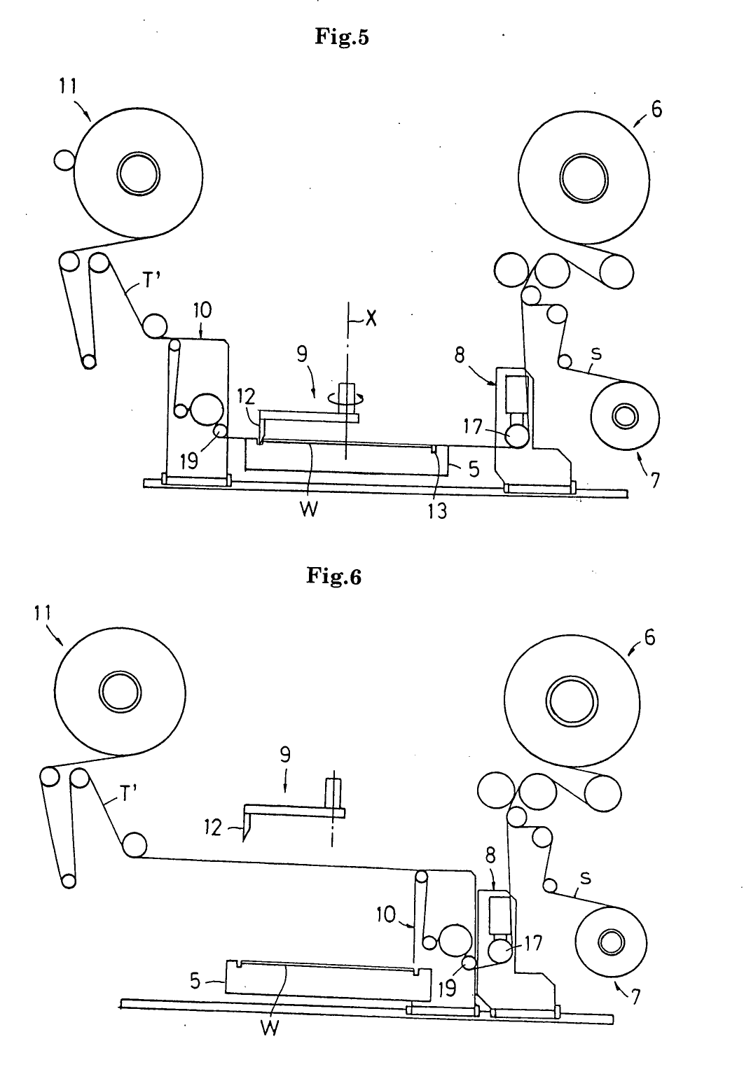

Next, as shown in FIG. 4, when the joining unit 8 reaches a termination position, the cutter blade 12 which has been on standby in the upper position descends as shown in FIG. 5. Then, the cutter blade 12 is stuck into the protective tape T positioned at a portion of the cutter running groove 13 in the chuck table 5.

When the cutter blade 12 is lowered to a predetermined cutting height position and stops, the cutter blade 12 turns and moves about the vertical axis X and the protective tape T is cut along the wafer outside shape. In this case, the cutter blade 12 runs while being pressed against the outer periphery of the wafer W to a proper degree by biasing force to carry out tape cutting along the outside shape of the wafer W.

After the tape cutting along the outer periphery of the wafer W is completed, the cutter blade 12 is lifted to the upper standby position as shown in FIG. 6. Then, the separation unit 10 rolls up the unnecessary tape T′ which has been cut out on the wafer W and left while the unit 10 moves forward.

After the separation unit 10 reaches a position of the end of the separating operation, the separation unit 10 and the joining unit 8 move in a reverse direction to return to the initial positions. At this time, substantially in synchronization with reeling of the unnecessary tape T′ by the collecting bobbin 20, a certain amount of protective tape T is unreeled from the tape supply unit 6.

When the actuation for joining and cutting the tape is finished, after the suction by the chuck table 5 is released, the wafer W which has been subjected to joining is transferred to the wafer holding unit 2a of the robot arm 2 and is inserted and collected into the cassette C in the wafer supply/collection unit 1.

Thus, one tape joining and cutting is completed and thereafter the above actuation is repeated successively.

In the tape cutting mechanism 9 having the above configuration and actuated in the above manner, a structure for increasing cutting ability is added in the present invention and some concrete examples will be shown below.

### First Example

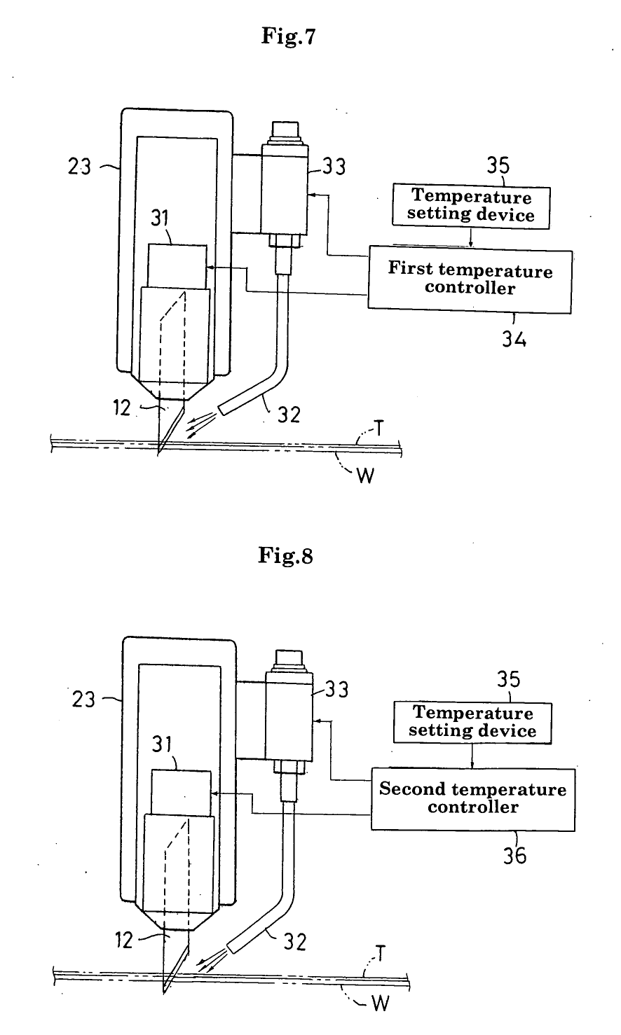

As shown in FIG. 7, the cutter holder 23 is mounted with an electrothermal heater 31 for heating the cutter blade 12 and is equipped with a cooler 33 for blowing air cooled by utilizing an electronic cooling element out of a cooling nozzle 32. The cooling nozzle 32 blows cooled air on the cutter blade 12. At this time, a flow amount and a temperature of the cooled air blowing out of the cooling nozzle 32 are regulated. The electrothermal heater 31 and the cooler 33 are connected to a first temperature controller 34 to maintain the cutter blade 12 at a set temperature by controlling electrical conduction of the electrothermal heater 31 and the cooler 33. A temperature setting device 35 is connected to the first temperature controller 34 to arbitrarily regulate a set temperature according to the type of the protective tape T and the like. In this case of the first example, it is preferable that the temperature of the cutter blade 12 is set at a temperature equal to or less than room temperature. It is more preferable that the temperature is in a range of −10 to 0° C. In other words, by maintaining the cutter blade 12 at the temperature equal to or less than the room temperature, the adhesive on the protective tape T becomes less liable to adhere to the cutter blade 12. The cooling nozzle 32 corresponds to cutter blade cooling means and the first temperature controller 34 corresponds to first temperature control means of the present invention.

As described above, if the cutter blade 12 is set to be cooled to the temperature equal to or less than the room temperature by the cooled air blowing out of the cooling nozzle 32, the adhesive on the protective tape T comes in contact with the cutter blade 12 and hardens. Therefore, the adhesive is prevented from adhering to and remaining on the side face of the cutter blade 12.

Moreover, increase in temperature of the cutter blade 12 due to frictional heat generated when the side face of the cutter blade 12 comes in sliding contact with the peripheral end edge of the wafer W can be suppressed.

Furthermore, the protective tape T is not melted or deformed at the portion where the cutting edge is stuck to thereby carry out cutting with a satisfactory finish.

A gaseous body used for cooling is not limited to the cooled air but other gaseous bodies may be used. For example, gasses and the like may also be used.

In the aforementioned case of the first example, even if heat from the cutter blade 12 is transferred to the adhesive on the protective tape T, the adhesive on the protective tape T is immediately cooled and hardened by the cooled air and the adhesive becomes less liable to adhere to the cutter blade 12. Moreover, with cool air flowing around the portion to be cut, the protective tape T can also be cooled to a proper degree to suppress hardening of the adhesive. Furthermore, the protective tape T cooled when the cutter blade 12 is stuck into the protective tape T is not melted or deformed by heat of the cutter blade 12. Therefore, it is possible to carry out the tape cutting with the satisfactory finish without adhesion of the adhesive.

### Second Example

As shown in FIG. 8, in this example, the cutter blade 12 is heated by an electrothermal heater 31 and cooled air blowing out of a cooling nozzle 32 is blown on the protective tape T to cool a vicinity of the portion of the protective tape to be cut. It is preferable that the cooled air is blown on a front region to which the cutter blade 12 moves or on a region including the portion to be cut. The electrothermal heater 31 and a cooler 33 are connected to a second temperature controller 36 to maintain a temperature of the portion of the cutter blade 12 to be cut at a predetermined temperature equal to or less than room temperature by controlling electrical conduction of the electrothermal heater 31 and the cooler 33. The second temperature controller 36 corresponds to second temperature control means of the present invention.

As described above, by heating the cutter blade 12, the portion of the protective tape T to be cut comes in contact with the cutter blade 12 and softens to thereby facilitate cutting. The portion of the protective tape T to be cut is not kept in the softened state but is cooled and the adhesive is also cooled and hardened immediately. Therefore, the protective tape T is prevented from being melted or deformed at the portion where the cutting edge is stuck and adhesion and remaining of a part of the adhesive to and on the side face of the cutter blade 12 are prevented.

The present invention can also be carried out in the following modes.

(1) The cooler 33 may be disposed at a fixed portion of the apparatus and the cooler 33 and the cooling nozzle 32 may be connected through a hose or piping.

(2) It is also possible that the temperature of the cutter blade 12 and the temperature of the portion of the protective tape T to be cut are detected successively and that the temperatures of the cutter blade and the protective tape T are adjusted successively according to the results.

In other words, at least one of the temperature of the cutter blade 12 and the temperature of the portion of the protective tape T to be cut is detected by a temperature sensor and a detected measured value is fed back to at least one of the first temperature controller 34 and the second temperature controller 36. Each of the respective controllers 34, 35 compares a predetermined reference temperature and the measured value to obtain a deviation. Then, based on this deviation, the temperature and the flow amount of the cooled air spouted from the cooling nozzle 32 and an output of the electrothermal heater 31 are regulated so that the temperature of the cutter blade 12 and the temperature of the portion of the protective tape T to be cut become equal to the reference values. With this structure, it is possible to carry out further stable temperature control.

(3) Although, in the aforementioned embodiment, an angle of the cooling nozzle 32 is fixed to a predetermined angle and the cooled air is blown on one of the cutter blade 12 and the protective tape T, an angle of a tip end of the cooling nozzle 32 may be swung up and down during cutting of the protective tape T to blow the cooled air on both of the cutter blade 12 and protective tape T at proper times. It is also possible that a plurality of cooling nozzles 32 are provided to simultaneously or intermittently blow the cooled air on the respective portions. It is also possible that the cooled air is blown on the cutter blade 12 and the protective tape T from an arbitrary position or angle around the cutter blade.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method for cutting a protective tape joined to a surface of a semiconductor wafer formed with a pattern by moving a cutter blade along an outer periphery of the semiconductor wafer, the method comprising the step of:
cutting the protective tape while cooling the cutter blade with cooling means.

2. The method according to claim 1, wherein
in the cutting step, the cutter blade is cooled with the cooling means and is heated with heating means to regulate a temperature of a cutting edge to a temperature equal to or less than room temperature.

3. A method for cutting a protective tape joined to a surface of a semiconductor wafer formed with a pattern by moving a cutter blade along an outer periphery of the semiconductor wafer, the method comprising the step of:
cutting the protective tape while cooling the protective tape with cooling means.

4. The method according to claim 3, wherein
in the cutting step, the protective tape is cooled with the cooling means and the cutter blade is heated with heating means to cut the protective tape while regulating a temperature of a portion of the protective tape with which the cutter blade is brought into contact to a temperature equal to or less than room temperature.

5. An apparatus for cutting a protective tape joined to a surface of a semiconductor wafer formed with a pattern, the apparatus comprising:
holding means on and at which the semiconductor wafer is mounted and held;
protective tape joining means for joining the protective tape onto the surface of the semiconductor wafer mounted on and held at the holding means;
protective tape cutting means having a cutter blade, and allowing the cutter blade to penetrate the protective tape and to move along an outer periphery of the semiconductor wafer, thereby cutting the protective tape joined to the surface of the semiconductor wafer;
cutter blade cooling means for cooling the cutter blade of the protective tape cutting means; and
tape collecting means for collecting an unnecessary protective tape after cutting.

6. The apparatus according to claim 5, wherein
the cutter blade cooling means is a cooling nozzle for blowing a cooled gaseous body on the cutter blade to cool the cutter blade.

7. The apparatus according to claim 5, wherein
the cutter blade cooling means is an electronic cooling element.

8. The apparatus according to claim 5, further comprising:
heating means for heating the cutter blade; and
first temperature control means for operating the heating means and the cooling means to regulate a temperature of the cutter blade.

9. The apparatus according to claim 8, further comprising:
a temperature sensor for detecting the temperature of the cutter blade, wherein
the first temperature control means compares a measured value detected by the temperature sensor and a predetermined reference value to obtain a deviation and operates the heating means or the cooling means according to the deviation to regulate the temperature of the cutter blade.

10. The apparatus according to claim 9, further comprising:
tape cooling means for cooling the protective tape.

11. The apparatus according to claim 10, wherein
the tape cooling means is a cooling nozzle for blowing a cooled gaseous body on and cooling the protective tape in a region in a vicinity of the cutter blade including a portion in contact with the cutter blade.

12. The apparatus according to claim 10, further comprising:
second temperature control means for operating the heating means and the tape cooling means to regulate the temperature of a portion of the protective tape to be cut.

13. The protective tape cutting apparatus according to claim 12, further comprising:
a temperature sensor for detecting the temperature of the portion of the protective tape to be cut, wherein
the second temperature control means compares a measured value detected by the temperature sensor and a predetermined reference value to obtain a deviation and operates at least the cooling means out of the heating means and the cooling means according to the deviation to regulate the temperature of the portion to be cut.

14. An apparatus for cutting a protective tape joined to a surface of a semiconductor wafer formed with a pattern, the apparatus comprising:
holding means on and at which the semiconductor wafer is mounted and held;
protective tape joining means for joining the protective tape onto the surface of the semiconductor wafer suction-held by the holding means;
protective tape cutting means having a cutter blade, and allowing the cutter blade to penetrate the protective tape and to move along an outer periphery of the semiconductor wafer, thereby cutting the protective tape joined to the surface of the semiconductor wafer;
tape cooling means for cooling the protective tape; and
tape collecting means for collecting an unnecessary protective tape after cutting.

15. The apparatus according to claim 14, wherein
the tape cooling means is a cooling nozzle for blowing a cooled gaseous body on and cooling the protective tape in a region in a vicinity of the cutter blade including a portion in contact with the cutter blade.

16. The apparatus according to claim 14, further comprising:
heating means for heating the cutter blade; and
second temperature control means for operating the heating means and the tape cooling means to regulate a temperature of a portion of the protective tape to be cut.

17. The apparatus according to claim 16, further comprising:
a temperature sensor for detecting the temperature of the portion of the protective tape to be cut, wherein
the second temperature control means compares a measured value detected by the temperature sensor and a predetermined reference value to obtain a deviation and operates at least the cooling means out of the heating means and the cooling means according to the deviation to regulate the temperature of the portion to be cut.
